(19) United States
(12) Patent Application Publication
(10) Pub. No.: US 2023/0366202 A1
(43) Pub. Date: Nov. 16, 2023

(54) ELONGATED SECTION FOR CONSTRUCTION STRUCTURES

(71) Applicant: POD Structures Pte Ltd, Singapore (SG)

(72) Inventor: Noah Samuel VEDANAIGAM, Singapore (SG)

(73) Assignee: POD Structures Pte Ltd, Singapore (SG)

(21) Appl. No.: 18/028,973

(22) PCT Filed: Sep. 30, 2021
(86) PCT No.: PCT/SG2021/050589

§ 371 Date: Mar. 28, 2023

(30) Foreign Application Priority Data
Sep. 30, 2020 (SG) 10202009717Y

(51) Int. Cl. E04C 3/30; B29C 64/393; B33Y 50/02

(52) U.S. Cl. CPC E04C 3/30; B29C 64/393; B33Y 50/02

(57) ABSTRACT

The present disclosure generally relates to an elongated section (101) for construction structures (300). The elongated section (101) comprises a plurality of sides (102), each side (102) comprising a first retaining channel (104) and a second retaining channel (105) adjacent a respective corner (106) of the elongated section (101), the first and second retaining channels (104,105) being a minor image of each other. Each retaining channel (104,105) is configured for engaging a respective retaining member (201) for supporting a structural panel (301) between the retaining members (201). Each retaining channel (104,105) comprises a channel slot (197) extending perpendicularly into the side (102), the channel slot (197) for engaging a first end (204) of the respective retaining member (201); and a channel end (198) opposite to the channel slot (197) for engaging a second end (206) of the respective retaining member (201).

### CROSS REFERENCE TO RELATED APPLICATION(S)

The present disclosure claims the benefit of Singapore Patent Application No. 10202009717Y filed on 30 Sep. 2020, which is incorporated in its entirety by reference herein.

### TECHNICAL FIELD

The present disclosure generally relates to an elongated section for construction structures. More particularly, the present disclosure describes various embodiments of an elongated section and a construction structure comprising the elongated section.

### BACKGROUND

Many construction structures are temporary or semi-permanent structures that are made for various events such as, for example, exhibitions, sporting events, conferences, seminars, symposiums, construction projects, disaster relief centres, and so forth. These construction structures may include accommodation, offices, storage and warehousing facilities, display stands, exhibition spaces, greenhouses, reception rooms, temporary flooring, cafes, restaurants, bistros, and so forth. They may be required for a few days, several months, or even years, depending on the duration of the events. These construction structures are often specially constructed using conventional construction techniques which are usually time-consuming, expensive, and the construction structures may be difficult to construct and dismantle. Moreover, the materials used for the construction structures often cannot be reused or recycled.

Therefore, in order to address or alleviate at least one of the aforementioned problems and/or disadvantages, there is a need to provide an improved construction structure.

### SUMMARY

According to a first aspect of the present disclosure, there is an elongated section for construction structures. The elongated section comprises a plurality of sides, each side comprising a first retaining channel and a second retaining channel adjacent a respective corner of the elongated section, the first and second retaining channels being a mirror image of each other. Each retaining channel is configured for engaging a respective retaining member for supporting a structural panel between the retaining members. Each retaining channel comprises a channel slot extending perpendicularly into the side, the channel slot for engaging a first end of the respective retaining member; and a channel end opposite to the channel slot for engaging a second end of the respective retaining member.

According to a second aspect of the present disclosure, there is a construction structure comprising the elongated section and a first retaining member for engaging with the first retaining channel of the elongated section. The first retaining member comprises the first end for engaging with the channel slot of the first retaining channel; and the second end opposite to the first end, the second end for engaging with the channel end of the first retaining channel.

An elongated section, as well as a construction structure comprising the elongated section, according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIGS. 1A to 1C are illustrations of an elongated section in accordance with embodiments of the present disclosure.

FIGS. 2A to 2C are illustrations of a construction structure comprising the elongated section and retaining members, in accordance with embodiments of the present disclosure.

FIGS. 3A to 3E are illustrations of another construction structure comprising the elongated section and retaining members, in accordance with other embodiments of the present disclosure.

FIGS. 4A to 4D are illustrations of connecting the elongated sections together, in accordance with embodiments of the present disclosure.

FIGS. 5A to 5F are illustrations of a construction system comprising a plurality of the construction structures, in accordance with embodiments of the present disclosure.

### DETAILED DESCRIPTION

Descriptions of embodiments of the present disclosure are directed to an elongated section and a construction structure comprising the elongated section, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “I” in a figure or associated text is understood to mean “and/or” unless otherwise indicated. The recitation of a particular numerical value or value range herein is understood to include or be a recitation of an approximate numerical value or value range. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The terms “first” and “second” are used merely as labels or identifiers and are not intended to impose numerical requirements on their associated terms. The term “each other” represents a reciprocal relation between two or more elements.

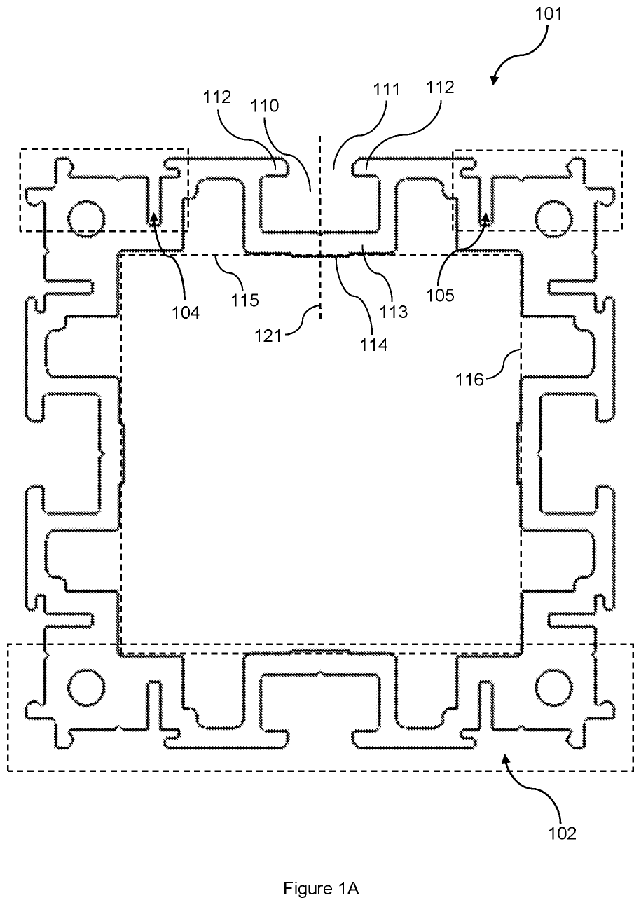

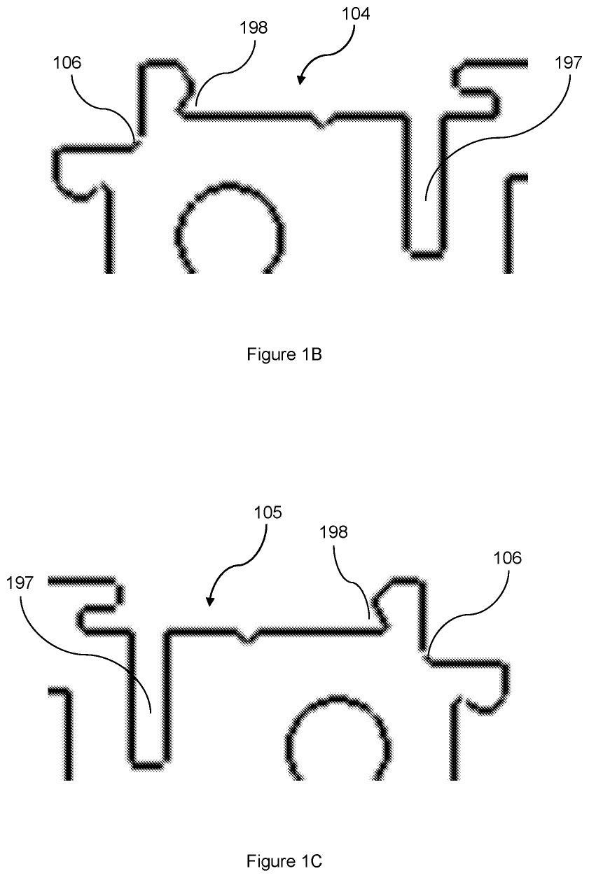

Representative or exemplary embodiments of the present disclosure describe an elongated section 101 for construction structures, as shown in FIG. 1A. The elongated section 101 may be made of any suitable material such as, for example, a metal. The metal may be, for example, stainless steel, mild steel, aluminium, and/or their alloys. The elongated section 101 includes a plurality of sides 102. For example as shown in FIG. 1A, the elongated section 101 has four mutually perpendicular sides 102 forming a rectangular cross-section. The sides 102 may be identical to each other forming a square cross-section. It will be appreciated that the elongated section 101 may have three, five, or more sides 102 forming a polygonal cross-section, wherein the sides 102 may or may not be identical to each other. The sides 102 may form a hollow core 103 or alternatively a solid core.

Each side 102 has a first retaining channel 104 and a second retaining channel 105 adjacent a respective corner 106 of the elongated section 101. The retaining channels 104,105 are a mirror image of each other about a central longitudinal axis 121 of the respective side 102. The retaining channels 104,105 may be identical to, spaced apart from, and/or parallel to each other.

Further as shown in FIG. 1B, the elongated section 101 further includes a central mounting channel 110 between the retaining channels 104,105. Each retaining channel 104,105 is used for engaging a respective retaining member 201 for supporting a structural panel 301 between the retaining members 201, as described further below. The central mounting channel 110 extends into the side 102 and generally parallel to the central longitudinal axis 121. The central mounting channel 110 may be equidistant from the retaining channels 104,105. The side 102 may project over the central mounting channel 110 to form two opposed retaining lips 112 that define an opening 111 to the central mounting channel 110. The central mounting channel 110 has a surface 114 formed on a base 113 and the surface 114 defines a base plane 115. The base planes 115 of the elongated section 101 define the cross-section of the elongated section 101, such as a hollow square 116 as shown in FIG. 1A.

Further as shown in FIGS. 1B and 1C, each retaining channel 104,105 includes a channel slot 197 that extends generally perpendicularly into the side 102 and generally parallel to the central longitudinal axis 121. The channel slot 197 may be referred to as a longitudinal slot. The channel slot 197 is used for engaging a first end 204 of the respective retaining member 201. Each retaining channel 104,105 further includes a channel end 198 opposite to the channel slot 197. The channel end 198 is used for engaging a second end 206 of the respective retaining member 201.

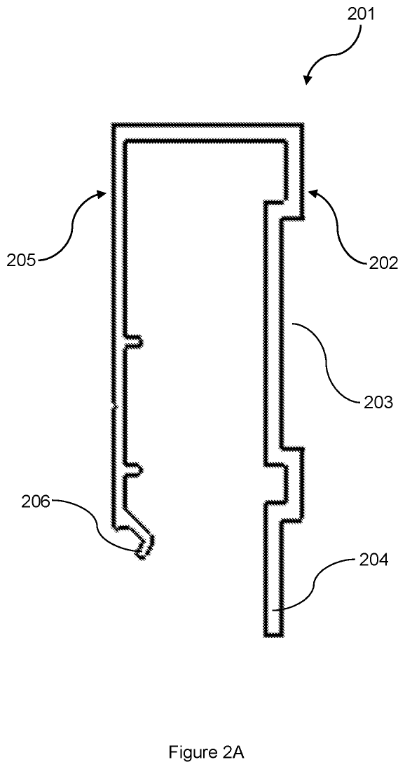

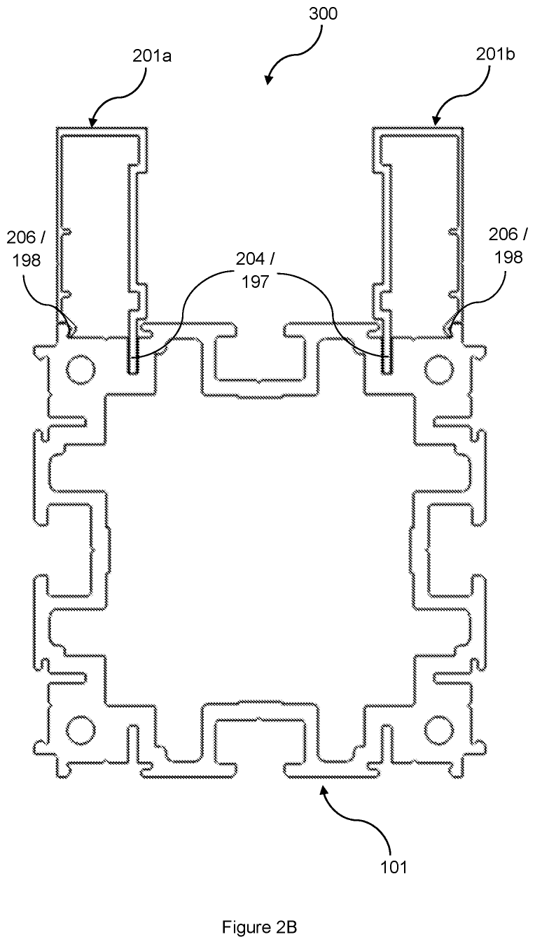

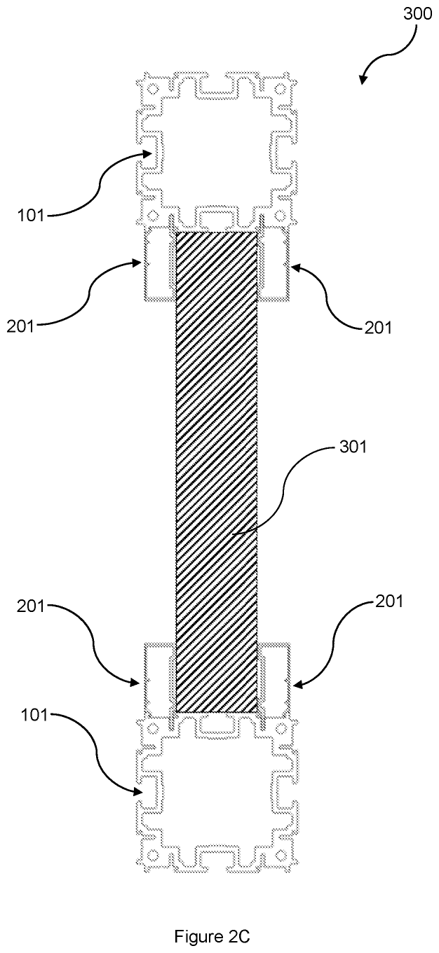

In some embodiments as shown in FIG. 2A, a retaining member 201 is shown for use with the elongated section 101. The retaining member 201 includes a front face 202 and a rear face 205 generally parallel to and integral with the front face 202. The front face 202 includes the first end 204 that extends generally downwardly from the front face 202 for engaging with the respective channel slot 197 of the respective retaining channel 104,105. The first end 204 is preferably coplanar and integral with the front face 202. The first end 204 may have roughened surfaces, such as jagged or toothed edges, to increase frictional forces with the channel slot 197 and strengthen the engagement. The rear face 205 includes the second end 206 that is opposite to the first end 204 and extends generally downwardly from the rear face 205 for engaging with the respective channel end 198 of the respective retaining channel 104,105. For example, the second end 206 includes a hook and the channel end 198 includes a notch, the hook and notch engageable with each other.

Each retaining member 201 is adapted to engage with the respective retaining channel 104,105 by first locating the first end 204 into the channel slot 197 and then compressing the rear face 205 so that the rear face 205 can move closer to the front face 202. The second end 206 with the hook can then engage with the notch at the channel end 198. The compression is released so that the rear face 205 can move away from the front face 202, thereby providing a secure engagement of the retaining member 201 with the respective retaining channel 104,105. By having the retaining member 201 inserted into place in a clip-like manner rather than a sliding manner, installation can be done more quickly and retaining members 201 with long lengths may be used without difficulty. Comparatively, normal sliding engagements across the whole length of the retaining member 201 can cause jamming during engagement, or may require great strength due to the frictional forces involved.

In some embodiments as shown in FIG. 2B, there is a construction structure 300 comprising the elongated section 101, a first retaining member 201a, and a second retaining member 201b. To assemble the construction structure 300, the first retaining member 201a is first inserted into the first retaining channel 104. The second retaining member 201b is then inserted into the second retaining channel 105 in an opposed manner to enable a structural panel 301, such as a wall panel, to be placed therebetween. The engagements of the first ends 204 with the channel slots 197, as well as of the second ends 206 with the channel ends 198, can be seen in FIG. 2B.

The structural panel 301 can then be inserted towards the central mounting channel 110 and in between the first retaining member 201a and second retaining member 201b. The structural panel 301 may alternatively be inserted before inserting the second retaining member 201b into the second retaining channel 105. Accordingly, the first retaining member 201a and second retaining member 201b sandwich the structural panel 301 to secure it to the elongated section 101. Further as shown in FIG. 2C, the structural panel 301 may be secured to two elongated sections 101 at both ends of the structural panel 301, together with respective pairs of retaining members 201.

The engagements of the first ends 204 of the retaining members 201 with the longitudinal channel slots 197 of the retaining channels 104,105 enable the structural panel 301 to be more securely attached to the elongated section 101. The structural panel 301 can withstand high wind loads when used outdoors. The structural panel 301 can support heavier wall systems when used in a larger construction system.

As shown in FIG. 2A, the front face 202 of the retaining member 201 includes a recess 203 for accommodating a resilient element. The resilient element may be a rubber or silicone strip that is attached by a suitable adhesive. The resilient element preferably projects beyond the front face 202 so that it can assist in tightly retaining the structural panel 301. The resilient element can allow or compensate for thermal expansion and contraction, as well as reducing movements, vibrations, rattles, and the like. The resilient element is also compressible to allow for insertion of the structural panel 301 or the second retaining member 201b after the structural panel 301 is in place.

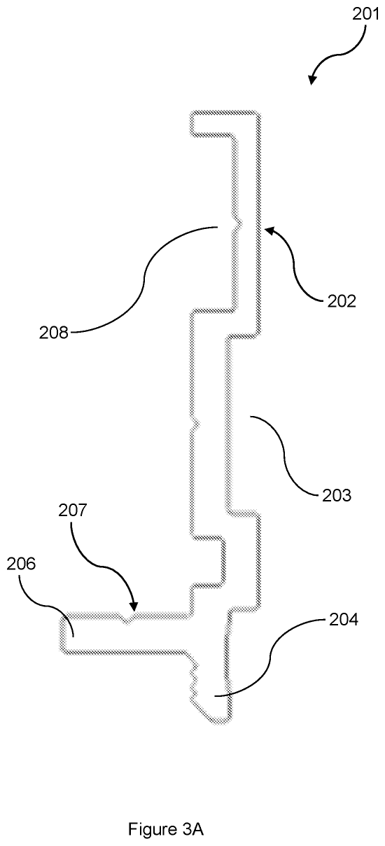

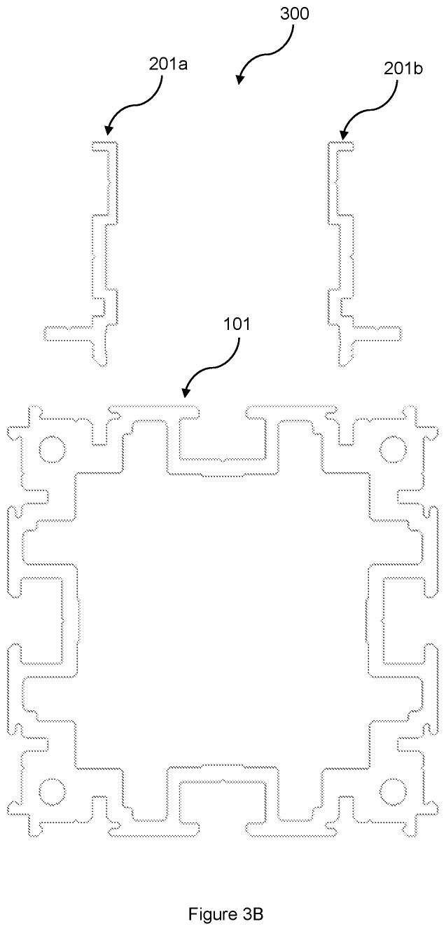

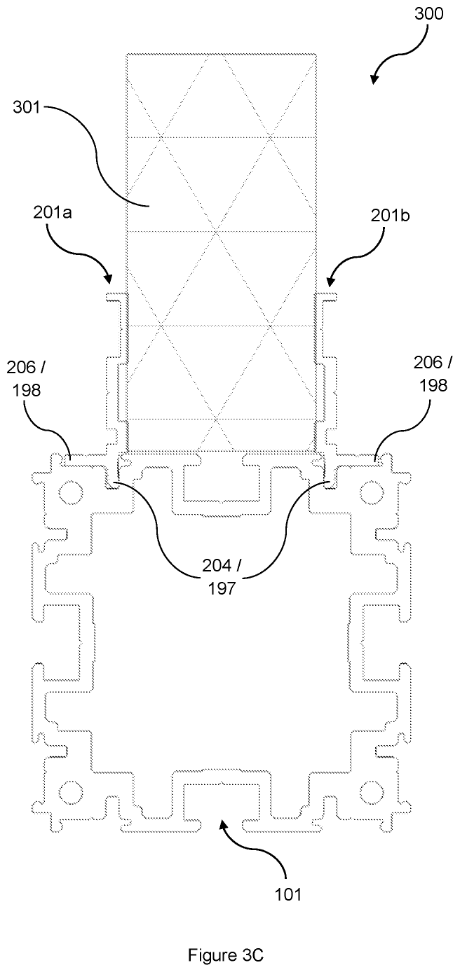

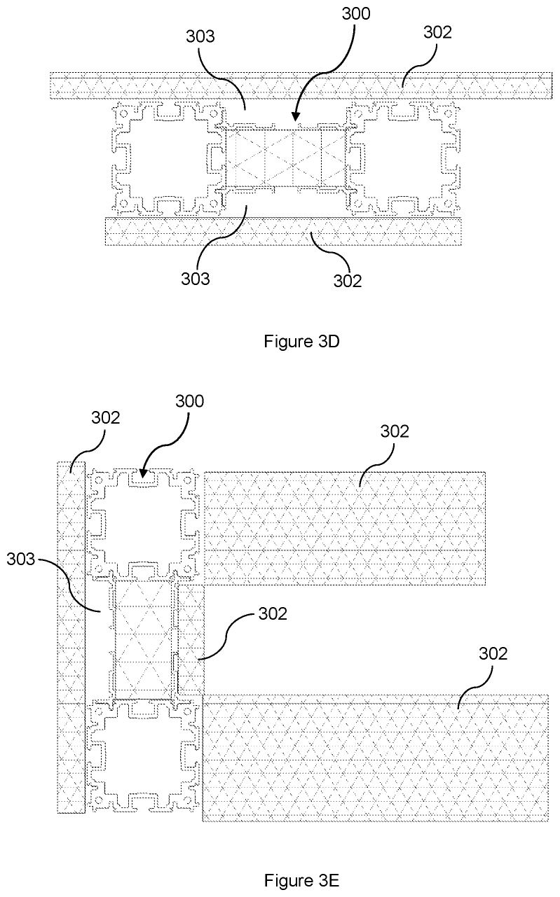

In some embodiments as shown in FIG. 3A, retaining members 201 are shown for use with the elongated section 101. Each retaining member 201 includes a front face 202 and a side face 207 generally perpendicular to and integral with the front face 202. The front face 202 includes the first end 204 that extends generally downwardly from the front face 202 for engaging with the respective channel slot 197 of the respective retaining channel 104,105. The first end 204 is preferably coplanar and integral with the front face 202. The first end 204 may have roughened surfaces, such as jagged or toothed edges, to increase frictional forces with the channel slot 197 and strengthen the engagement. The side face 207 includes the second end 206 that is opposite to the first end 204 and extends generally sideways from the front face 202 for engaging with the respective channel end 198 of the respective retaining channel 104,105. The front face 202 may include a first recess 203 for accommodating a resilient element. The front face 202 may include a second recess 208 for accommodating a fastener such as a screw.

Further as shown in FIGS. 3B and 3C, there is a construction structure 300 comprising the elongated section 101, a first retaining member 201a, and a second retaining member 201b. To assemble the construction structure 300, the first retaining member 201a and second retaining member 201b are inserted into the first and second retaining channels 104,105 respectively and the structural panel 301 is placed in between the first retaining member 201a and second retaining member 201b. The structural panel 301 may be fastened to the first retaining member 201a and second retaining member 201b using fasteners at the second recesses 208. A corresponding set of elongated section 101, first retaining member 201a, second retaining member 201b is engaged with the structural panel 301 at the opposing end thereof, thereby securing the structural panel 301 to the elongated sections 101.

As shown in FIGS. 3D and 3E, the construction structure 300 may be installed with structural walls 302 to form a larger wall system or construction system. Spaces 303, such as between the structural panel 301 and structural walls 302, may be filled with suitable materials depending on the desired properties. For example, the spaces 303 may be filled with an insulation material such as rockwool to improve thermal and acoustic performance.

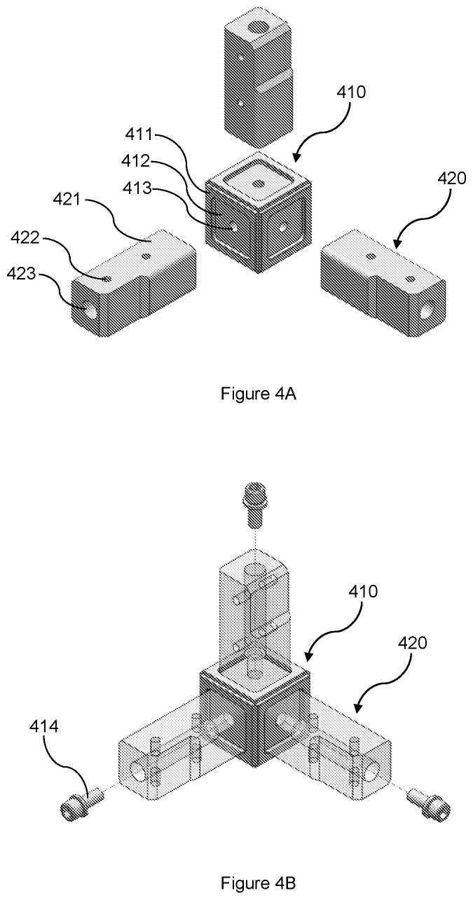

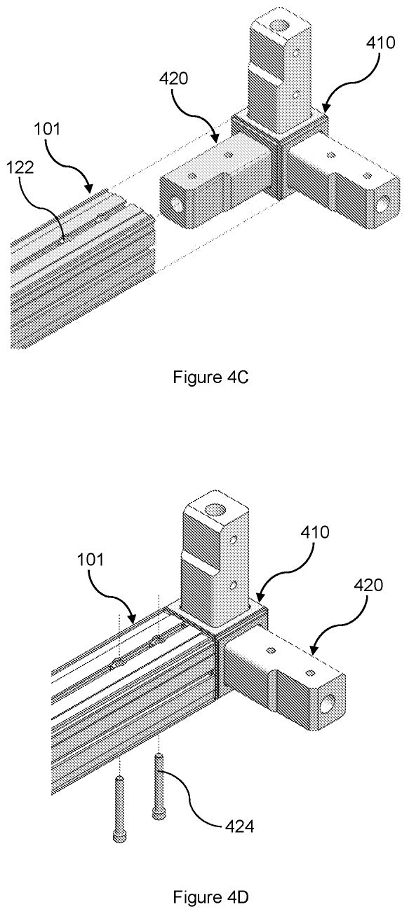

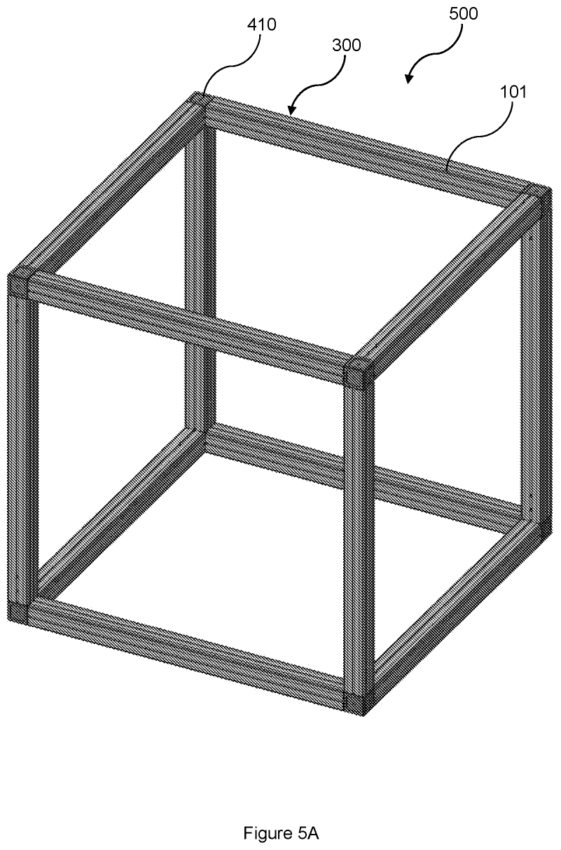

The elongated section 101 is configured to be used with corner blocks 410 and connectors 420, as shown in FIGS. 4A to 4D. Each corner block 410 is a cube having six faces 411. Each face 411 has a recess 412 and a threaded hole 413 through each face 411 at the centre of each central recess 412. The threaded hole 413 is able to receive a correspondingly-threaded fastener 414. The connectors 420 are of a square cross-section having four sides 421 each with a plurality of bolt holes 422. The bolt holes 422 may be threaded. Each connector 420 has a central hole 423 for insertion of the fastener 414. The connector 420 is connected to the corner block 410 by the fastener 414 through the threaded hole 413. The outer dimensions of the connector 420 are preferably matched to the dimensions of the recess 412 so that the connector 420 can be accurately located relative to the corner block 410 prior to the fastener 414 being tightened. The outer dimensions of the connector 420 are preferably matched to the inner dimensions of the elongated section 101 so that the connector 420 can form a close but slideable fit inside the elongated section 101. The elongated section 101 preferably has holes 122 in each side 102 that align with the bolt holes 422 to enable the elongated section 101 can be releasably attached to the connector 420. For example, bolts 424 are fastened through the holes 122 and bolt holes 422 to releasably attach the elongated section 101 to the connector 420. In this way, the corner block 410 and connectors 420 can be used to securely yet releasably attach up to six elongated sections 101.

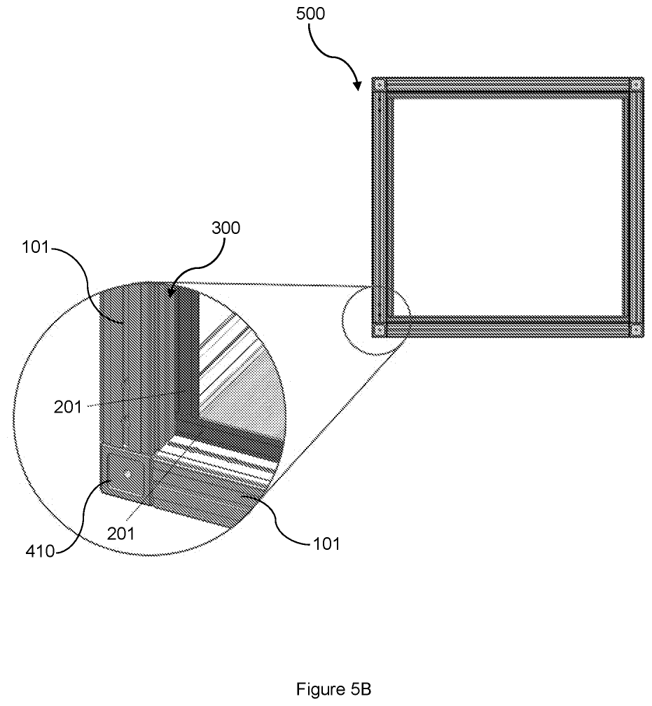

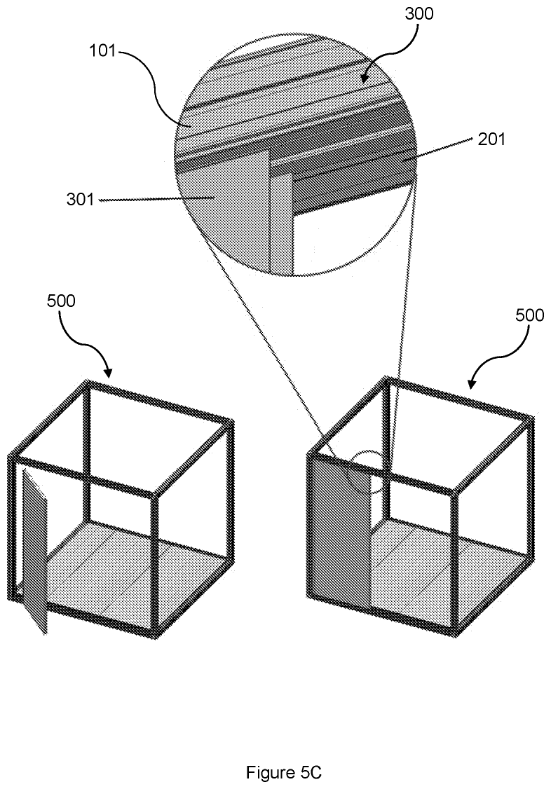

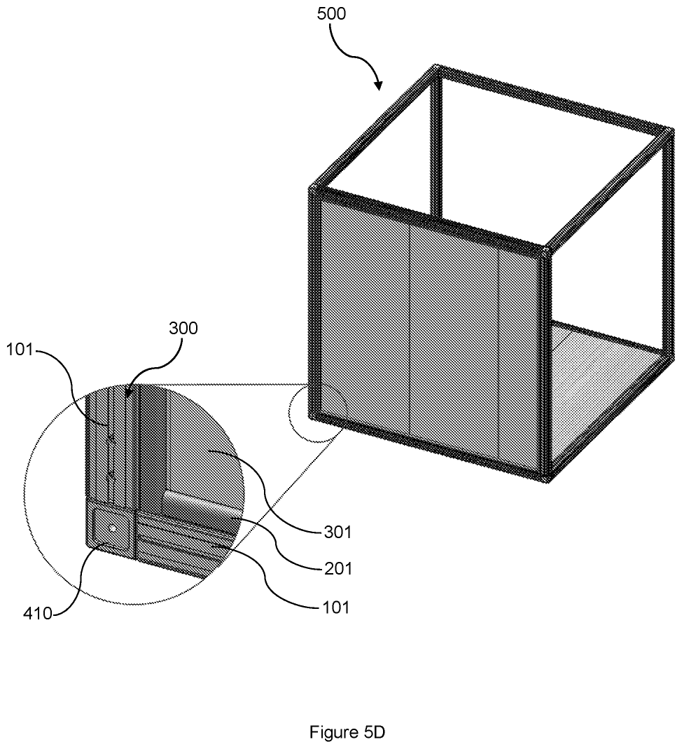

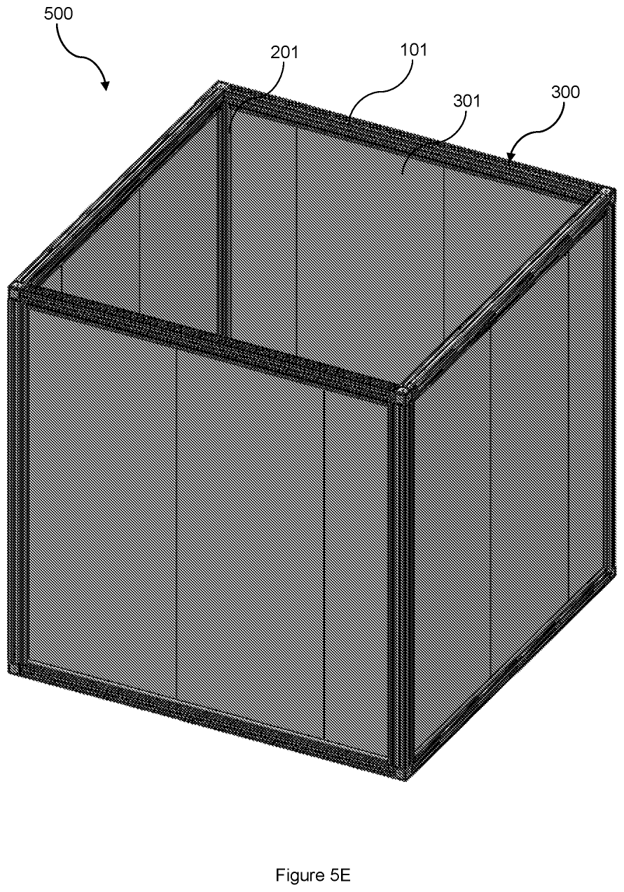

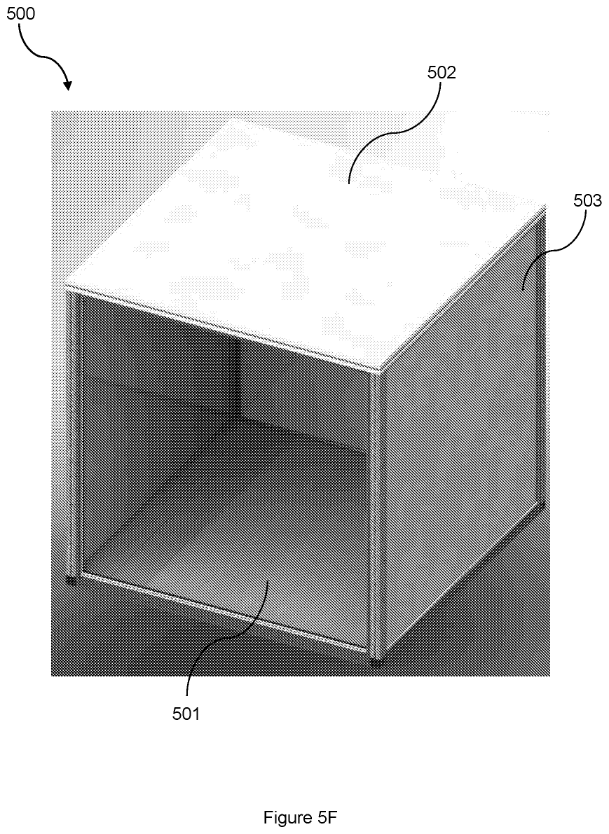

FIG. 5A shows a construction system 500 comprising a plurality of construction structures 300 joined together. Specifically, the construction system 500 has four corner blocks 410 and twelve elongated sections 101, each elongated section 101 joined to respective retaining members 201. FIGS. 5B to 5D further show the construction system 500 being assembled with the retaining members 201 and structural panel 301. The structural panel 301 is inserted between the retaining members 201 that are engaged with the elongated sections 101. FIG. 5E shows the assembly process repeated for the other three sides of the construction system 500.

FIG. 5F shows an example of a completed construction system 500 that further includes a floor 501, ceiling 502, and side walls 503. The construction system 500 may be single storey as shown or may have multiple storeys. The construction system 500 may be constructed as temporary, semi-permanent, or permanent constructions. Specifically, the engagement between the retaining members 201 and the retaining channels 104,105 due to the channel slots 197 improves the structural connection between the structural panel 301 and the elongated section 101. This allows the construction system 500 to withstand high loads which is often in the building code for permanent constructions.

The elongated section 101 can be fabricated by various manufacturing methods using various materials such as metals. In some embodiments, the elongated section 101 is manufactured by extrusion. In some embodiments, the elongated section 101 or a product comprising it may be formed by a manufacturing process that includes an additive manufacturing process. A common example of additive manufacturing is three-dimensional (3D) printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a 3D component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, moulds, or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modelling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNS), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM), and other known processes.

The additive manufacturing processes described herein may be used for forming components using any suitable material. For example, the material may be metal, plastic, polymer, composite, or any other suitable material that may be in solid, liquid, powder, sheet material, wire, or any other suitable form or combinations thereof. More specifically, according to exemplary embodiments of the present disclosure, the additively manufactured components described herein may be formed in part, in whole, or in some combination of materials suitable for use in additive manufacturing processes and which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on 3D information, for example a 3D computer model (or design file), of the component. Accordingly, examples described herein not only include products or components as described herein, but also methods of manufacturing such products or components via additive manufacturing and computer software, firmware or hardware for controlling the manufacture of such products via additive manufacturing.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for Stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any 3D object to be fabricated on any additive manufacturing printer. Further examples of design file formats include AutoCAD (.dwg) files, Blender (.blend) files, Parasolid (.x_t) files, 3D Manufacturing Format (.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product. Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known CAD software systems such as AutoCAD®, TurboCAD®, DesignCAD 3D Max, etc. Alternatively, a model or prototype of the product may be scanned to determine the 3D information of the product. Accordingly, by controlling an additive manufacturing apparatus according to the computer executable instructions, the additive manufacturing apparatus can be instructed to print out the product.

In light of the above, embodiments include methods of manufacture via additive manufacturing. This includes the steps of obtaining a design file representing the product and instructing an additive manufacturing apparatus to manufacture the product according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

In the foregoing detailed description, embodiments of the present disclosure in relation to an elongated section and a construction structure comprising the elongated section are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An elongated section for construction structures, the elongated section comprising a plurality of sides, each side comprising:
a first retaining channel and a second retaining channel adjacent a respective corner of the elongated section, the first and second retaining channels being a mirror image of each other;
each retaining channel configured for engaging a respective retaining member for supporting a structural panel between the retaining members; and
each retaining channel comprising:
a channel slot extending perpendicularly into the side, the channel slot for engaging a first end of the respective retaining member; and
a channel end opposite to the channel slot for engaging a second end of the respective retaining member.

2. The elongated section according to claim 1, wherein the channel end comprises a notch for engaging with a hook of the second end of the respective retaining member.

3. The elongated section according to claim 1, wherein the elongated section comprises four mutually perpendicular sides.

4. The elongated section according to claim 1, wherein the sides are identical to each other.

5. The elongated section according to claim 1, further comprising a hollow core.

6. A construction structure comprising:
the elongated section according to claim 1;
a first retaining member for engaging with the first retaining channel of the elongated section, the first retaining member comprising:
the first end for engaging with the channel slot of the first retaining channel; and
the second end opposite to the first end, the second end for engaging with the channel end of the first retaining channel.

7. The construction structure according to claim 6, further comprising a second retaining member for engaging with the second retaining channel of the elongated section, the second retaining member comprising:
the first end for engaging with the channel slot of the second retaining channel; and
the second end opposite to the first end, the second end for engaging with the channel end of the second retaining channel.

8. The construction structure according to claim 6, wherein each retaining member comprises:
a front face comprising the first end extending downwardly from the front face for engaging with the respective channel slot; and
a rear face parallel to and integral with the front face, the rear face comprising the second end opposite to the first end, the second end extending downwardly from the rear face for engaging with the respective channel end.

9. The construction structure according to claim 8, wherein the front face comprises a recess for accommodating a resilient element.

10. The construction structure according to claim 8, wherein the first end comprises roughened surfaces.

11. The construction structure according to claim 6, wherein each retaining member comprises:
a front face comprising the first end extending downwardly from the front face for engaging with the respective channel slot; and
a side face perpendicular to and integral with the front face, the side face comprising the second end opposite to the first end, the second end extending sideways from the front face for engaging with the respective channel end.

12. The construction structure according to claim 11, wherein the front face comprises a first recess for accommodating a resilient element.

13. The construction structure according to claim 11, wherein the front face comprises a second recess for accommodating a fastener.

14. The construction structure according to claim 11, wherein the first end comprises roughened surfaces.

15. The construction structure according to claim 6, further comprising the structural panel supported between the retaining members.

16. A computer program comprising computer executable instructions that, when executed by a processor, cause the processor to control an additive manufacturing apparatus to manufacture a product comprising the elongated section according to claim 1.

17. A method of manufacturing a product via additive manufacturing, the method comprising:
obtaining an electronic file representing a geometry of the product wherein the product comprises the elongated section according to claim 1; and
controlling an additive manufacturing apparatus to manufacture, over one or more additive manufacturing steps, the product according to the geometry specified in the electronic file.
